(19) United States
(12) Patent Application Publication
(10) Pub. No.: US 2005/0102235 A1
(43) Pub. Date: May 12, 2005

(54) Method and system for processing of documents with electronic signatures

(76) Inventor: Michael Waidner, AU-Waedenswill (CH)

Correspondence Address: Louis J Percello;IBM Corporation, Intellectual Property Dept, P O Box 218, Yorktown Heights, NY, 10598, US

(21) Appl. No.: 10/467,111

(22) PCT Filed: Dec. 20, 2001
(86) PCT No.: PCT/EP01/15159

(30) Foreign Application Priority Data
Jan. 10, 2001 (EP) 011005691

(51) Int. Cl. G06F 17/60

(52) U.S. Cl. 705/51

(57) ABSTRACT

The present invention relates to a method and corresponding system for the computerized processing of documents with electronic signatures. For providing an electronically signed document to an exploiter the current invention suggests a first step of transforming a signer machine-readable source format of the document into a universal format representing said document identically and independently from a computer system used for its representation. In a second step the electronic signature is created based on the universal format of the document. Finally in a third step the electronic signature and a single representation of the document in an exchange format is provided to an exploiter. For further processing of the electronically signed document by an exploiter it is suggested to validate the electronic signature by transforming the exchange format of the document into the universal format of the document and validating said signature with respect to said universal format of the document. Finally an exploiter machine-readable source format of the document is created from its exchange format.

### 1. BACKGROUND OF THE INVENTION

1.1 Field of the Invention

The present invention relates to a method and corresponding system for the computerized processing of documents with electronic signatures.

1.2 Description and Disadvantages of Prior Art

Electronic signatures are a key component for the security of electronic commerce: essentially they allow to mimic the function of handwritten signatures in the digital world.

For instance, if a party A wants to digitally sign any kind of document like for instance a contract c comprising digital data d then A applies his or her secret signature key sk to this data, resulting in a electronic signature s. A secure electronic signature scheme guarantees that without knowing sk nobody can create an electronic signature s that would pass the verification with the corresponding public verification key pk. Thus everybody who knows pk can verify that indeed A's corresponding secret signature key was used to create s from d. If the system is properly set-up and operated this gives strong evidence that indeed A electronically signed the data d.

In order to conclude “A signed contract c” the link between the contract c and the data d representing it for A must be unambiguous for everybody who relies on A's signature, or in other words: applications using electronic signatures have to provide an “unambiguous interpretation” for signed data. Such an interpretation ensures that it is impossible to find two different contracts c₁ and c₂ which are both represented by the same data d.

Very often this is not the case. For instance, assume that d is a document written in some modern word processor supporting macros (e.g., Microsoft Word). Document d might result in different visual representations on different machines, i.e. in visually and semantically different contracts c₁ and c₂. For instance, two computers might have two versions of a font installed, one using the symbol for Italian Lira instead of the symbol for European Euro. Obviously this could result in significantly different contracts, one talking about Lira, the other about Euro. Or d might include a macro that shows completely different text depending on the current time and date, or d might include hyperlinks to other documents which might be replaced over time, and so on. Using a presentation-oriented format like PDF or Postscript does not improve the situation, as such languages basically offer the same features (macros, hyperlinks, use of installed fonts). Expressed in more general terms the observation is that context dependencies influencing the interpretation of document d might be different on different systems which store and interpret the signed contract, resulting in documents with different meaning. As explained, the result could be that document d has been signed electronically by party A having one interpretation on party A's system but once that signed document has been transmitted to a third party's B system it unfolds to a different interpretation though party B can verify that the document has been signed by party A. Clearly such different interpretations induced by the context cannot be legally binding to the signing party A.

One possible solution to this problem is to fix an interpretation that is independent of these existing word processors and presentation-oriented formats.

It has been proposed to directly sign the graphical representation, i.e., c is something that can be displayed on a computer screen, and d is basically the graphical representation of this document on the computer screen.

While this solves the interpretation problem it introduces a new one: it is not possible anymore to process the signed data automatically, as the information about the components and their internal structure and layout of the data is lost. As the signed document has simply become an image it has become impossible to process the document further in the course of electronic commerce by exploiters.

Therefore all other attempts according to the state of the art to solve the interpretation problem have chosen a different direction consisting of two parts: 1.) a representation d* in a certain simple formal language that can be processed automatically but cannot be shown to the user directly (e.g., an XML-based signature mark-up language), and 2.) an interpreter that hopefully unambiguously maps this d* to something that can be shown to the user, e.g., a bitmap. Despite of these approaches most concrete proposals still suffer from some of the problems mentioned before (e.g., they still depend on the fonts installed on the system, so a Lira symbol might still be replaced by a Euro symbol); or in other words, a stable interpretation cannot be guaranteed. But the main problem is that they require all applications that produce data that shall be signed or that process signed data to use this language for their outputs or inputs, respectively. Therefore, this is a very inflexible and limiting approach.

In one proposed embodiment of this approach d* actually represents a pair of documents (d, d′) where d is a bitmap and d′ is a representation that can be automatically processed. The bitmap fixes the interpretation like in the first approach, but the link between d and d′ is not verified, i.e., there is no guarantee that they actually correspond to each other. Nothing prevents a cheating signer to make up arbitrary, unrelated pairs (d, d′).

1.3 Objective of the Invention

The invention is based on the objective to provide a technology which unequivocally guarantees a well-defined and stable interpretation of an electronically signed document and which at the same time provides an approach facilitating automatic further processing of electronically signed documents in the course of electronic commerce.

### 2. SUMMARY AND ADVANTAGES OF THE INVENTION

The objectives of the invention are solved by the independent claims. Further advantageous arrangements and embodiments of the invention are set forth in the respective subclaims.

The present invention relates to means, a method and a computer program product for providing an electronically signed document to an exploiter. The current invention suggests a first step of transforming a signer machine-readable source format of the document into a universal format representing said document identically and independently from a computer system used for its representation. In a second step the electronic signature is created based on the universal format of the document. Finally in a third step the electronic signature and a single representation of the document in an exchange format is provided to an exploiter.

Moreover the present invention relates to means, a method and a computer program product for further processing of the electronically signed document by an exploiter. It is suggested to validate the electronic signature by transforming the exchange format of the document into the universal format of the document and validating said signature with respect to said universal format of the document. Finally an exploiter machine-readable source format of the document is created from its exchange format.

The suggested approach supports that only a single representation of an electronically signed document has to be exchanged. At the same time the invention achieves that an unequivocally well-defined, stable and unambiguous interpretation of the electronically signed document can be guaranteed. Furthermore the invention provides an approach facilitating automatic further processing of electronically signed documents in the course of electronic commerce.

### 3. BRIEF DESCRIPTION OF THE DRAWINGS

FIGS. 1 and 2 shows the control and data flow of two possible embodiments of the current invention.

### 4. DESCRIPTION OF THE PREFERRED EMBODIMENT

In the drawings and specification there has been set forth a preferred embodiment of the invention and, although specific terms are used, the description thus given uses terminology in a generic and descriptive sense only and not for purposes of limitation. It will, however, be evident that various modifications and changes may be made thereto without departing from the broader spirit and scope of the invention as set forth in the appended claims.

The present invention can be realized in hardware, software, or a combination of hardware and software. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product which comprises all the features enabling the implementation of the methods described herein, and which—when being loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

The current invention uses the term “document” in its most general meaning referring to any type of entity for which an electronic signature may be generated. Examples for such documents are declarations, agreements, depictions, contracts, graphics, audio/video data or any other arbitrary type of signable data.

4.1 Solution

A solution to above mentioned objectives can be achieved according to the following fundamental observations:
1. When providing an electronically signed document by a signer it is not advisable to create an electronic signature based on a signer's machine-readable source format of that document. As discussed above a signer machine-readable source format of a document always has to be interpreted by the computer system of an exploiter. Due to context dependencies influencing this interpretation process an unequivocal and stable interpretation of a document cannot be guaranteed when exchanging this document in the course of business.
2. The current invention therefore suggests to first transform the machine-readable source format of the signer of a document into a universal format representing the document identically and independently from a computer system used for its representation. Such a representation is necessary to guarantee an unequivocal semantic of the document being independent from the context in which the representation is used. Such a universal format of a document may be its graphical representation, i.e., something that can be displayed on a computer screen like the set of (black/white or colored) pixels that represent this document on the computer screen. Another example for such a universal representation would be the binary representation of the document with respect to a certain printer type. Of course many more such universal formats do exist. In the following we call such a representation a bitmap.
3. It is further suggested to create the electronic signature based on the universal format of the document, i.e. not based on the signer machine-readable source format. As background information with respect to electronic signatures it is noted that the created electronic signature is depending on the document for which the signature is created; that is, 2 different documents or 2 different representations of the same document would result in different electronic signatures even if signed by the same signer.
4. When the signer of that document introduces the document into the course of business it is suggested
   a. to provide the electronic signature based on said universal format of the document and
   b. a single representation of the document in an exchange format (the exchange format being characterized by allowing an exploiter to create the universal format of the document himself based on the exchange format of the document) to the exploiters of the document. As a single representation of the document is exchanged only the current solution can guarantee that no synchronization problem occurs like in situations where tupels of documents are exchanged (refer to the discussion above) which are susceptible for cheating signers. Using an electronic signature based on the universal format of the document guarantees a fixed and unequivocal interpretation.
5. Once the document in its universal format and the electronic signature is available to the exploiter the current invention teaches the exploiter to transform the received exchange format of the document into the universal format of the document. Based on the universal format of the document a validation of the signature can be performed. Finally, the exploiter creates an exploiter machine-readable source format of the document from the exchange format; this exploiter machine-readable source format would then form the basis for further automatic processing of the document by the exploiter endowed with the confidence to match the interpretation of the document as actually signed by the signer.
As to the exchange format of the document 2 possible solution examples are provided by the current invention.
   5.1 In a first solution the exchange format is identical to the universal format of the document. In this situation the validation of the electronic signature is possible right away using standard techniques. The exploiter machine-readable source format of the document can be created for instance by applying pattern recognition technology to the universal format, which would recognize and extract the individual components within the document. As a specific pattern recognition approach the OCR techniques could be used for instance.
5.2 In the second solution the exchange format of the document is identical (up to trivial representational differences relating for instance to different operating systems) with the signer machine-readable source format of the document. In this situation creation of the exploiter machine-readable source format is very simple as it is identical to the exchange format of the document, or can be easily derived from it. The validation process of electronic signature actually is a repetition of a step which also has been performed by the signer. The exploiter of the document would use the signer machine-readable source format of the document to transform it into its corresponding universal format; having this available it can be verified if the electronic signature has been created for the just created universal format of said document.
   4.2 Two Possible Embodiments of the Current Invention

The following preferred embodiments of the current invention refer to a system with communicating entities, such as computers in a network, that can play three roles, C (as the creator of the applications that produce or further process signed documents), S (as the signer of a document), P (as the processor, or in other words the exploiter, of a document). Of course these communicating entities may also be realized within a single computer system playing the roles described above. Moreover, some of these roles may be combined into the single entity; for instance the role of the creator c and the role of the signer s maybe combined into a single signer role S. Therefore, the introduction of these roles should be understood from a conceptual point only and do not relate to a physical separation which has to be enforced by the invention.

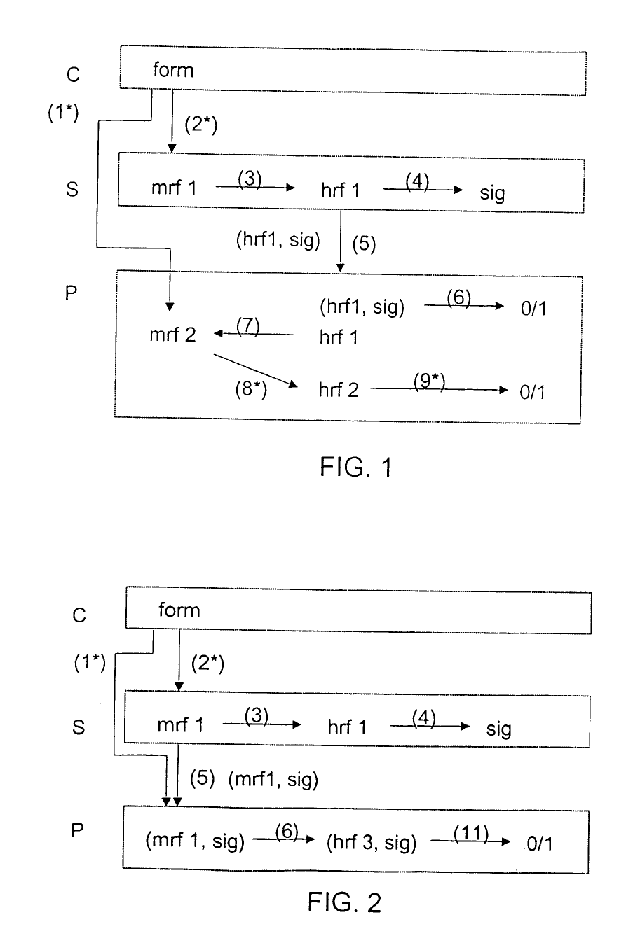

A first preferred embodiment of the current invention is shown in FIG. 1.

As a signer, S, an entity produces the data, that is the document, to be signed in some machine readable form mrf1, also referred to as the signer machine-readable source format of the document in the following. In Step (3) signer S transforms mzrf1 into a human readable form hrf1, a bitmap, which is in Step (4) electronically signed, yielding signature sig. Generally hrf1 is the universal format representing the document identically and independently from a computer system used for its representation. Such a representation is necessary to guarantee an unequivocal interpretation of the document being independent from the context in which the representation is used. In this specific embodiment of the current invention the universal format hrf1 has been chosen to be human readable at the same time.

In Step (5) the signature sig and a single representation of that document are sent to an entity P, acting as processor or in other words as exploiter of the document. As said single representation of the document an exchange format is used. In this concrete embodiment of the invention the universal format, that is the human readable format hrf1, is used as said exchange format.

As a side remark it should be mentioned that signature systems exist which, when creating an “electronic signature”, actually do create a combination of the signed document and the “proper” electronic signature. Within such contexts it would of course be sufficient that within Step (5) such an “integrated” electronic signature is sent to the processor P only. Similar obvious modifications in other parts of the representation of the current invention would have to take place without deviating from the spirit of the proposed invention if such signature systems are used to implement the current invention. Thus, the current specification is using the term of an electronic signature as referring to the proper electronic signature only not including the signed document.

In Step (6) processor P verifies the validity of signature sig, as defined for the electronic signature system used. It is pointed out that the signature verification takes place with respect to the document in its universal format, that is in its format hrf1. Result 0 indicates that the verification failed (i.e., sig is not a valid signature on hxf1), in which case P raises an exception and does not process hrf1 further. Result 1 indicates that sig is a valid signature and hrf1 can be processed further.

In Step (7) processor P extracts from hrf1 a machine readable form mrf2 (also referred to as the exploiter machine-readable source format of the document in the following) that can be used for automatic processing. This extraction is done, for instance, by applying well-known techniques from OCR or some other pattern recognition technologies to a bitmap hrxf1, or to specific parts of a bitmap. mrf2 does not necessarily represent all the data signed, i.e., the implicit mapping from mrf1 to mrf2 is not necessarily infective.

In an optional Step (8*) mrf2 is mapped to a human readable form hrf2, and in an optional Step (9*) hrf1 and hrf2 are compared. This comparison might be, for instance, a test for equality of all of hrf1 and hrf2, or a test for equality of certain parts of hrf1 and hrf2.

Step (6) does not need to be performed first; instead it can be arbitrarily parallelized with Steps (7), (8*), (9*), or postponed until a proof of validity is actually needed.

In optional Steps (1*) and (2*) a creator, C, sends information used to create mrf1, hrf1 and mrf2, hrf2 to S and P, respectively. This can happen any time before the other steps are taken, and once together for several executions of the other steps. The information C sends completely or partially specifies the application that is used by S to produce mrf1 and hrf1, and the application used by P to extract mrf2 from hrf1 and to produce hrf2. This indication on the application used to create the signer machine-readable source format of that document may be exploited by the pattern recognition technology in creating the exploiter machine-readable source format of the document.

A second preferred embodiment of the current invention is shown in FIG. 2 reflecting a variant of the first embodiment.

Steps (3) and (4) are realized as before. The human readable form hrf1 might be a bitmap, or any other universal format of the document that can be unambiguously presented to the user.

In Step (5) the machine readable form mrf1 and signature sig are sent to an entity P. As a difference with respect to the first embodiment the document is provided to the exploiter in the signer machine-readable source format mrf1 as exchange format of said document.

In Step (6) processor P repeats Step (3) of the signer and produces the same universal format of the document, which has been created by the signer to sign the document. In the current embodiment this means to create a human readable form hrf3 from mrf1. In a further optional improvement of this embodiment the signer could provide within Step (5) to the exploiter a further indication by which application the universal format hrf1 of the document has been created. This would allow the exploiter to use exactly this application for transforming the signer machine-readable source format mrf1 of said document into said universal format hrf3 thus excluding any potential ambiguities within this transformation process.

In Step (11) processor P verifies the validity of signature sig relative to the self-constructed universal format hrf3 of the document. If sig is valid and the signature scheme is secure then hrf3=hrf1, i.e., this demonstrates that sig is a valid signature on hrf1 as well. Like before, Step (11) can be postponed until a proof of validity is actually needed.

In the optional Steps (1*) and (2*) a creator, C, sends information used to create mrf1, hrf1 and hrf3 to S and P, respectively. This can happen any time before the other steps are taken, and once together for several executions of the other steps. This information completely or partially specifies the applications that are used by C and P to produce mrf1, hrf1 and hrf3.

1. A computerized method for providing an electronically signed document by a signer of said document,
said method comprising
a first step (3) of transforming a signer machine-readable source format (mrf1) of said document into a universal format (hrf1) representing said document identically and independently from a computer system used for its representation, and
a second step (4) of creating an electronic signature (sig) based on said universal format of said document, and
a third step (5) of providing to an exploiter of said document said electronic signature and a single representation of said document in an exchange format allowing said exploiter
to verify validity of said signature with respect to said document in said universal format, and
to create an exploiter machine-readable source format of said document for further processing by said exploiter in validated conformance with said representation of said document in said universal format.

2. The method according to claim 1,
wherein in said third step said exchange format is said universal format of said document, and
said exploiter machine-readable source format of said document being creatable from said universal format by post-processing.

3. The method according to claim 1,
wherein in said third step
said exchange format of said document is said signer machine-readable source format and said exploited machine-readable source format being a representation of said signer machine-readable source format, and
said exploiter being allowed to validate conformance with said universal format by transforming said signer machine-readable source format of said document into said universal format and by validating said provided signature against said universal format of said document.

4. The method according to claim 2,
said method further providing to said exploiter a first indication by which first computer-based application said signer machine-readable source format of said document has been created allowing said exploiter to create said exploiter machine-readable source format for said first application during said post-processing.

5. The method according to claim 3,
said method further providing to said exploiter a second indication by which second application said universal
format of said document has been created allowing said exploiter to use said second application for transforming said signer machine-readable source format of said document into said universal format.

6. The method according to claim 4 or 5,
wherein said universal format is a pixel representation of said document, or
wherein said the universal format is a bit-map, or
wherein said universal format is a binary representation of said document with respect to a certain printer type.

7. A computerized method for further processing of an electronically signed document by an exploiter,
said method comprising
a first step (5) of receiving
a single representation of said document in an exchange format, and
an electronic signature (sig) based on said universal format of said document, said universal format representing said document identically and independently from a computer system used for its representation,
a second step of validating (6, 11) said signature by transforming said exchange format of said document into said universal format (hrf1) of said document and validating said signature with respect to said universal format of said document, and
a third step of creating (5, 7) an exploiter machine-readable source format of said document from said exchange format.

8. The method according to claim 7,
wherein in said first step said exchange format is said universal format of said document, and
wherein in said third step said exploiter machine-readable source format of said document is created from said universal format.

9. The method according to claim 8,
wherein said exploiter machine-readable source format of said document is created from said universal format by pattern recognition technology.

10. The method according to claim 7,
wherein in said first step said exchange format of said document is said signer machine-readable source format and wherein in said step third step said exploiter machine-readable source format being a representation of said signer machine-readable source format.

11. The method according to claim 8,
wherein in said first step further receiving a first indication by which first computer-based application said signer machine-readable source format of said document has been created, and
wherein in said third step said exploiter machine-readable source format is created for said first application.

12. The method according to claim 10,
wherein in said first step further receiving a second indication by which second computer-based application said universal format of said document has been created, and
wherein in said second step using said second application for transforming said signer machine-readable source format of said document into said universal format.

13. The method according to claim 9 or 11,
wherein said universal format is a pixel representation of said document, or
wherein said the universal format is a bit-map, or
wherein said universal format is a binary representation of said document with respect to a certain printer type.

14. System comprising means adapted for carrying out the steps of the method according to anyone of the preceding claims 1 to 6.

15. System comprising means adapted for carrying out the steps of the method according to anyone of the preceding claims 7 to 13.

16. A data processing program for execution in a data processing system comprising software code portions for performing a method according to anyone of the preceding claims 1 to 6 when said program is run on said computer.

17. A computer program product stored on a computer usable medium, comprising computer readable program means for causing a computer to perform a method according to anyone of the preceding claims 1 to 6 when said program is run on said computer.

18. A data processing program for execution in a data processing system comprising software code portions for performing a method according to anyone of the preceding claims 7 to 13 when said program is run on said computer.

19. A computer program product stored on a computer usable medium, comprising computer readable program means for causing a computer to perform a method according to anyone of the preceding claims 7 to 13 when said program is run on said computer.
